(19) United States
(12) Patent Application Publication
(10) Pub. No.: US 2015/0157423 A1
(43) Pub. Date: Jun. 11, 2015

(54) PROVIDING NON-INVASIVE FACIAL SUPPORT AND FACIAL PROPORTIONING

(71) Applicant: Samuel Charles Muslin, Pacific Palisades, CA (US)

(72) Inventor: Samuel Charles Muslin, Pacific Palisades, CA (US)

(21) Appl. No.: 14/103,682

(22) Filed: Dec. 11, 2013

(51) Int. Cl. A61C 7/36; A61C 7/00

(52) U.S. Cl. CPC A61C 7/36; A61C 7/002

(57) ABSTRACT

A method for providing facial proportioning for a patient to realize an idealized bite and jaw positioning includes bonding a set of dental appliances to at least one set of dental arches of the patient is described. The bonding includes: cleaning a surface of the at least one set of dental arches, wherein the cleaning including: applying micro air-abrasion to surface contaminants on the surface of the at least one set of dental arches; etching away the surface contaminants; and applying a desensitizer and antiseptic material to the surface, wherein the at least one set of dental appliances provides a dental reconstruction that achieves an idealized bite and jaw positioning for the patient.

### BACKGROUND

Traditional dentistry provides various techniques for addressing dental problems (e.g., overbites, underbites, eroded bites, etc.). Orthodontists, general dentists and/or oral surgeons generally tend to recommend braces, full mouth reconstructions, and/or surgery to address such problems. In many instances, in order to correct these dental problems, patients endure hospitalization to have one or both of their jaws cut, have their jaw wired shut during the healing period, have their teeth ground down, and wear braces for an extended period of time. The complications and risks of surgery are extensive and the seemingly endless amount of time required to wear these braces can be exhausting for the patient. The complications and risks of grinding down teeth for crowns are significant and can leave the patient in constant pain or discomfort with compromised structural integrity of the teeth. Thus, the traditional treatment methods for correcting bite and jaw positions present many problems and undesirable side effects.

### BRIEF DESCRIPTION OF DRAWINGS

FIGS. 1A and 1B show x-ray photos taken with a complex motion tomography machine, in accordance with embodiments.

FIGS. 2A and 2B illustrate before and after front view pictures of Patient “A” with an underbite, in accordance with embodiments.

FIGS. 2C and 2D illustrate before and after side profile pictures of Patient “A” with an underbite, in accordance with embodiments.

FIGS. 3A and 3B illustrate before and after side profile pictures of Patient “B” with an overbite, in accordance with embodiments.

FIGS. 4A and 4B illustrate before and after front view pictures of Patient “C” with an eroded and aging bite, in accordance with the embodiments.

FIG. 5 is a flow chart of an example method 500 for providing facial proportioning for a patient to realize an idealized bite and jaw positioning, in accordance with embodiments.

FIG. 6 is a flow chart of an example method 600 for providing facial proportioning for a patient to realize an idealized bite and jaw positioning, in accordance with embodiments.

FIG. 7 is a flow chart of an example method 700 for providing facial proportioning for a patient to realize an idealized bite and jaw positioning, in accordance with embodiments.

FIG. 8 is a flow chart of an example method 800 for providing facial proportioning for a patient to realize an idealized bite and jaw positioning, in accordance with embodiments.

FIG. 9 is a flow chart of an example method 900 for providing facial proportioning for a patient to realize an idealized bite and jaw positioning, in accordance with embodiments.

FIG. 10 is a block diagram of an example system 1000 for providing facial proportioning for a patient to realize an idealized bite and jaw positioning, in accordance with embodiments.

The drawings referred to in this description should be understood as not being drawn to scale except if specifically noted.

### DESCRIPTION OF EMBODIMENTS

The discussion below begins with a brief overview description of embodiments of the present technology for providing a patient with idealized facial support and facial proportioning non-invasively. The discussion then turns to a description of various bite and jaw positions that are less than ideal and the consequences therefrom to patients. Further, an explanation is given of traditional dental techniques of addressing these problems and consequences. The discussion then turns to a detailed description of embodiments of the present technology that enable the idealization of a patient's bite and jaw position, thereby resolving the dental problems associated with a poor bite and jaw position.

### Overview

Various embodiments of the present technology provide non-surgical methods for providing a patient with facial support and facial proportioning, enabling the patient's bite position (i.e., the way that the patient's teeth fit together) and jaw position to be idealized. More particularly, embodiments include using a novel bonding procedure that provides a non-invasive and pain-free method of applying a dental appliance(s) to a patient's teeth. Some embodiments use information acquired from complex motion tomography generated images to create dental appliances that provide a patient with idealized facial support and facial proportioning without grinding down their healthy natural teeth.

### Bite and Jaw Position Problems

A less than ideal bite and jaw position may occur in a wide variety of circumstances, such as, but not limited to, the following: an overbite; an underbite; an uncomfortable bite, an eroded bite; and an aging bite. Following is a general description of an overbite and underbite as it relates to embodiments to be presented in detail below.

### Overbite

An overbite commonly refers to a lower jaw being too far behind the upper jaw or a misalignment of the teeth. The lower jaw commonly appears physically smaller than the upper jaw and it leads to the perception of a weak chin and jaw. Adverse consequences of an overbite include, but are not limited to, the following: jaw pain; neck pain; headaches; clicking and popping jaw; teeth grinding; enamel wear; inhibited breathing; and slurred speech.

### Underbite

An underbite commonly refers to a malocclusion in which the lower teeth protrude beyond the upper teeth. The lower jaw commonly appears physically larger than the upper jaw because of the associated bite and jaw position. An underbite may cause excessive enamel wear on the back teeth, digestive problems, trouble chewing, slurred speech, annunciation problems, as well as low self-esteem.

### Eroded Bite or Aging Bite

An eroded bite or aging bite commonly refers to teeth or a dental arch(s) that are shortened and worn. The teeth may exhibit extensive enamel wear that can be uneven, thereby causing tooth sensitivity, tooth mobility, tooth discoloration, trouble chewing, digestive problems, inhibited airway access, jaw pain, facial tension, a clicking and popping jaw, grinding, clenching, and headaches.

Consequences of a Less than Ideal Bite and Jaw Position

As indicated above, a person with a less than ideal bite and jaw position may experience a multitude of problems. A more extensive recounting of these problems includes, but is not limited to, the following: aging effects (e.g., weak chin, disappearing lips, sunken cheeks, jutting chins, sagging skin, bad facial shape, imbalances in the proportions of the profile, wrinkles); chewing problems; digestive problems (e.g., acid reflux); reduced nutrient absorption; reduced airway; difficulty breathing; sleep problems; body fatigue; TMJ pain; muscle tiredness; tension in the face; headaches; chronic clenching; grinding of the teeth; and low self-esteem. A person may find it necessary to take medication to alleviate many of the problematic symptoms related to poor bite and jaw positioning.

As noted above, a less than idealized bite may affect many aspects of a person's life. A more thorough description of several examples (digestive problems, TMJ pain, clenching/grinding, aging, reduced airway) is described immediately below.

### Digestive Problems

A person's poor bite and jaw positioning affects that person's ability to chew his food thoroughly and efficiently. Many problems result when a person's bite and jaw position is less than ideal or when their upper and lower jaw are misaligned. When any part of the chewing system is out of synch, it can lead to many problems. Poor bite positioning may both subconsciously and consciously cause a person to stop chewing his food thoroughly or comfortably. For example, when a person finds that it is difficult and/or painful to close his teeth together, the person may simply chew his food as little as possible. This partially broken down food is then introduced into the digestive tract. The digestive tract is required to break down the food at least to the extent that the chewing process should have. Over time, digestive issues, such as acid reflux, may occur as the body struggles to digest large food particles.

### TMJ Pain

In some cases, the TMJ muscles overcompensate for a bad bite position. The jaw muscles of a person force his teeth to meet each other in order that the food may be chewed. By repeatedly forcing his bite to assume an unhealthy position, a person may begin to experience muscle tightness, pain and fatigue in his jaw, face, neck and ears area.

### Clenching/Grinding

A misaligned bite and jaw position may lead to increased clenching and/or grinding. During sleep, some amount of clenching and grinding of the teeth is normal. As this night time reflex progresses over time, it can lead to, at least, enamel erosion, shortened or worn down teeth, root exposure and tooth sensitivity, and tooth mobility or loss. The more clenching and grinding that is done, both during the day and night, the more the bite is worn down (as well as unevenly worn down). This situation tends to get worse over time and the symptoms increase, causing greater tooth sensitivity, tooth damage, jaw pain, muscle tightness, headaches and difficulty chewing.

### Aging

As a person ages, his teeth get shorter (i.e., the bite position loses height and dimension). From the cosmetic perspective, as teeth are worn down and getting shorter, the teeth may begin looking yellow or grey in color. The edges of the teeth may become chipped and uneven, or even look sawed off. As the teeth shorten, they start to disappear from the smile. This shortening of the teeth provides, for many, an undesirable aging effect. Shortened teeth and bad bite and jaw positioning cause a person's face to physically shorten with age such that he looks older than he would with teeth that are not worn down. The jaw position is directly affected leaving the overall shape of the face and profile compromised. The mouth, lips, cheeks, neck, speech, ability to chew, jaw position and airway are all adversely affected by this physical shortening of the face.

### Reduced Airway

One consequence of a shortening face, eroded, and/or aging bite and jaw position is a reduced airway. As the access to the airway gets smaller, it becomes more difficult to breath as efficiently. Without efficient breathing, a person may lose energy and vitality, causing his appearance to seemingly age. Many people do not sleep as well as they slept when they were younger because of the reduced airway access caused by a collapsing bite and shifting jaw position. Due to the smaller airway, a person may start to snore and also wake up several times during the night as his body fights for oxygen. Many people seek treatment and/or start taking sleeping pills. Unfortunately, these sleeping pills (and alternatives) do nothing to treat the actual problem of an aging bite and a shifting jaw position. An older person's uncorrected bite and shifted jaw position, which may cause a drop in normal blood oxygen levels, a compromised chewing ability and reduced nutrient absorption, ages him from the inside out.

### Traditional Dentistry Solutions

Traditional dentistry attempts to resolve some of those problems presented above by providing a full mouth reconstruction and bite correction procedures, via invasive oral surgery, grinding down teeth to attach new dental appliances, pain medication, and/or extended wear-time in braces. Traditional dentistry focuses on problems that can be seen, such as removing tooth decay, extracting hopeless teeth, placing porcelain crowns, fillings and dental implants. Traditional dentistry typically involves grinding down teeth for porcelain crowns or veneers that may give a patient whiter teeth and an improved smile. However, when the patient is not smiling, the benefit of the whiter smile is lost on the viewer. Other traditional solutions for anti-aging techniques are face-lifts. However, face-lifts cannot physically lengthen a person's face, or support the person's cheeks and/or lips. Traditional underbite treatment options may include chin caps, expanders, reverse-pull face mask, orthodontic braces and jaw surgery.

### Embodiments

Embodiments provide methods and systems for providing facial support and facial proportioning non-invasively and without grinding down healthy teeth, including a novel method for bonding a dental appliance to each individual tooth on all of the patient's upper teeth and/or all of the patient's lower teeth. The dental appliance for this new bite position is designed around the patient's specific TMJ anatomy in order to improve the patient's comfort and health, as well as the efficiency and aesthetics of the patient's lower jaw, facial shape, soft tissue of the face, and facial proportions. The term, “non-invasive” as it relates to the embodiments, refers to the approach, process, and application of the appliances to the patient's natural teeth with the exception of technical interferences, wherein the patient's healthy natural teeth are not subjected to drilling, cutting, or grinding by a dental drill or any other mechanism. More specifically, injections and anesthetic are not needed for the patient's comfort in the adjustment of technical interferences nor in the application of the appliances, as the patient's healthy teeth are not altered such that they cannot remain as healthy natural teeth without the need for a dental appliance, crown, veneer, filling, etc.

Embodiments involve a three dimensional approach to the patient's bite and jaw position treatment, enabling the patient's bite to be designed such that his jaw is repositioned easily, and his teeth neutrally support the soft tissue of his face. As such, embodiments enable the improvement of a person's entire facial appearance and thereby the attainment of a younger look, without facial surgery, implants, Botox and/or the injection of facial fillers, braces and without the grinding down of healthy teeth.

When the patient's bite and jaw position are idealized, the patient's teeth and dental appliances that are bonded thereon provide adequate support for the patient's facial structure, an enhanced facial shape, and improved profile proportions. In general, the idealized bite and jaw position of a patient is that bite and jaw position that significantly improves the positioning and proportions of the bite and jaw over that which currently exists such that the adverse effects of a poor bite and jaw position described herein are reduced or eliminated. Thus, the dental appliance bonded onto a patient's teeth in accordance with embodiments, not only reverse years of tooth wear but function to support the patient's soft tissue (e.g., lips, cheeks) for a more youthful appearance for the patient. For example, thin lips can appear fuller without artificial fillers and implants because the lips are supported by the patient's newly restored bite position. In another example, the patient's jawline looks stronger or in better proportion to the rest of the patient's face. Thus, the shape, length and proportions of the patient's face are optimized via the idealization of the patient's bite and jaw positioning.

As will be further discussed below, various embodiments include, but are not limited to, any of the following method steps: 1) replacing dental work in patient's mouth; 2) gathering data; 3) defining goals; 4) testing assumptions; 5) designing a new bite and jaw position; 6) trying-on the new appliances; 7) bonding the new appliances; 8) fine tuning the bite and jaw position; and 9) protecting the investment. It should be appreciated that the foregoing steps may occur in a different order from that which is described below. Of further note, the dentist performing the methods described herein, in accordance with embodiments, will need expertise (and/or access to such expertise) in TMJ medicine and neuromuscular dentistry, as well as be experienced with full mouth reconstructions. As will be shown, embodiments enable achieving the patient's best bite position non-invasively by providing the ideal jaw position for the patient's facial structure and health. An embodiment of the present technology generates the Venlay™, owned by Dr. Sam Muslin.

Reference will now be made in detail to embodiments of the present technology for providing facial support and facial proportioning without surgery or grinding down healthy teeth, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures and components have not been described in detail as not to unnecessarily obscure aspects of the present embodiments.

The method steps of idealizing a bite and jaw position of a patient are explained below, in accordance with embodiments.

### I. Replacing Dental Work in the Patient's Mouth

Many times, a patient has a variety of old dental work on his teeth, applied at different times, over a span of many years. Old and older technology is found within the patient's mouth, none of which is built onto the teeth to coordinate with each other to achieve the ultimate objective of idealizing the patient's bite position. In one embodiment, the dentist replaces all of the patient's old dental work (e.g., crowns, fillings) with a new layer of protection, all of the new dental work will be applied in coordination with each other, to maximize and idealize the patient's bite and jaw positioning.

A patient who has received treatment according to embodiments may experience the reversal of premature aging, better lip and soft tissue support, reduced facial folds or wrinkles, a better overall facial shape and improvements in his chin jawline and facial profile. Thus, a patient who has received treatment according to embodiments may experience less jaw tension and TMJ pain, better sleep, more efficient and comfortable chewing capacity, easier digestion, and a more youthful appearance. Having an optimized jaw and bite position that is achieved non-invasively benefits a patient's health because it benefits the patient's entire body.

Of note, traditional teeth reconstruction treatment either replaces all of the old crowns, old fillings or bad porcelain veneers during a period of weeks, several months or even years. When performing this type of reconstruction treatment over a period of several months or years, the individual teeth may be improved, but the height and position of the bite as well as the jaw position remain the same as it was before the treatment began. This means if the patient has a weak chin or an aging face before the treatment, the patient will not likely experience any cosmetic improvements under traditional treatment methods. Likewise, if the patient has TMJ pain or headaches resulting from a bad bite and jaw position, they will not likely experience any health benefits relative to their jaw pain and headaches, as traditional treatment methods will not improve the position of the bite and jaw.

When performing traditional reconstruction treatment over just a few weeks, the dentist has an advantage in having the opportunity to have all of the porcelain prepared at the same time. By preparing all of the porcelain at the same time, the porcelain color will match and the function of the bite can be moderately improved. Missing teeth, chewing issues, tooth sensitivity and decay may be dramatically improved in this type of reconstruction. However, since this type of bite reconstruction does not involve idealizing the jaw position, the patient will not likely experience any anti-aging benefits or improvements to his facial shape or profile. Likewise, performing traditional reconstruction treatment involves grinding down several, if not all, of the patient's teeth upper teeth and/or lower teeth, leaving the teeth structurally compromised and with significant risks to and/or additional undesirable effects for the patient, including but not limited to, tooth sensitivity, tooth loss, pain both temporary and long-term, the need for further invasive endodontic care, etc.

### II. Gathering Data

In various embodiments, the dentist conducts a dental examination of the patient. The dentist investigates/examines any, but not limited to, of the following: the patient's history; how the patient speaks and moves; the patient's speech problems and/or bite interferences that affect the patient's diction and/or movements; bite balance, comfort, deviations, wear and function; which of the patient's teeth are visible when the patient speaks; periodontal charting; the patient's tissue; the overall shape of the patient's face; where the patient may need soft tissue support (e.g., lips, corners of the mouth, below the jawline or chin, cheeks); which lips need support; the patient's profile to determine if he could benefit from better proportioning (e.g., does the patient's chin stick out, is the patient's lower jaw weak and recessed, is one of the patient's lips more prominent than the other, is the patient's mouth sunken in and are the patient's lips squished); aspects of the patient's TMJ (e.g., clicking, popping, irregular movement, deviations, overbuilt muscles, tension, and facial movement); signs of wear and grinding of the patient's teeth; gum recessions; fractures; thinning enamel; dental x-rays; areas of infection; areas of potential infection; and the patient's own description, opinion, and assessment of their symptoms, concerns, and goals.

The dentist then demonstrates to the patient the effects while using a bite tester that is intended to simulate a reconstruction of the teeth that would idealize the patient's bite and jaw position. The dentist determines the best bite tester of the different sizes of bite testers, through and acute observation of the patients jaw movements and known or observed information from the dental examination, that best simulates the patient's ideal bite and jaw position.

Once the best bite tester is determined, the dentist takes head shots, profile shots, and mouth photos of the patient, without the bite testers in place.

The dentist will also take impressions for creating a dental model of the patient's upper and lower dental arches and ultimately for creating bite test appliances to be worn by the patient. The testing appliance is made out of thermal plastic, in one embodiment. This thermal plastic is melted over the top of the dental model of the patient's teeth as a base. The test appliance's height is then adjusted three dimensionally according to observations of the patient by the dentists and the patient's feedback, comfort, speech and movements to achieve an improved bite via the test appliance.

### III. Defining Goals

In various embodiments, the dentist will discuss any specific goals the patient has with regard to tooth reconstruction and whether these goals are realistic. For example, the patient and the dentist may discuss the possibility of a wider smile, a younger face, a better looking profile, TMJ pain relief, etc.

In one embodiment, the dentist will discuss color options for reconstructive work. For example, the dentist may point out that the porcelain color that could be chosen is that color that is closest to the whites of the patient's eyes, which will give the patient's face color balance and harmony.

In one embodiment, the dentist will discuss the general style and shape of restorative work that the dentist is recommending and why such a recommendation is being made. The dentist will explain to the patient that the patient is not taking a risk by allowing the dentist to make some style decisions on his behalf as the patient will try-on the restorative proposed appliances and that they will not be bonded into place until the patient approves. The patient will get to wear the try-on appliances around the office and with assistance walk outside to natural light to determine if the patient likes the look. Any changes that the patient may desire to be made to the appliances may be made overnight or over a prearranged timeline. The next appointment, the patient may then be able to try-on the altered/modified appliance. Only when the patient gives his approval (the assumption being that the patient is satisfied with the proposed appliances) will the appliances be bonded into place in the patient's mouth.

In one embodiment, the dentist will explain to the patient the necessary steps to be taken to achieve good oral health and what is expected of the patient before, during and after treatment.

### IV. Testing Assumptions

In one embodiment, testing assumptions occur during the observation and exploration period of the test appliance. The dentist makes any necessary three-dimensional bite adjustments to the testing appliance based upon observation of the patient, patient feedback and data such as complex motion tomography.

The dentist takes at least one complex motion tomography photo from one side of the patient of the following positions of the patient's mouth: the mouth opened wide; the mouth biting naturally; the mouth biting with the testing appliance; and the mouth at rest. At least one complex motion tomography photo is then taken from the patient's other side in the same positions as the former. Based upon the x-ray results of the complex motion tomography images, the testing appliance may be adjusted if necessary. When considering altering a patient's jaw position, it should be appreciated that in traditional dentistry, dentists x-ray a patient's jaw joint with a CAT scan machine to gain a highly detailed photograph of the position of the patient's jaw bone and the placement of an implant during a surgical procedure. As the CAT scan machine gives off high amounts of undesired radiation, the dentist is only able to take a limited number of images of the patient, thus limiting the dentist's ability to gather all the information needed to provide the best treatment possible. In the alternative, the dentist takes a large amount of CAT scan images, thus exposing the patient to large amounts of undesired radiation. Embodiments, on the other hand, provide a method in which a complex motion tomography machine is used to take images showing the patient's jaw joint in multiple positions before and after testing appliances are fitted onto the patient's teeth. The complex motion tomography machine emits minimal radiation and the quality of the resulting images is useful for the purpose of determining the patient's ideal jaw position and ultimately for manufacturing the necessary jaw repositioning appliances.

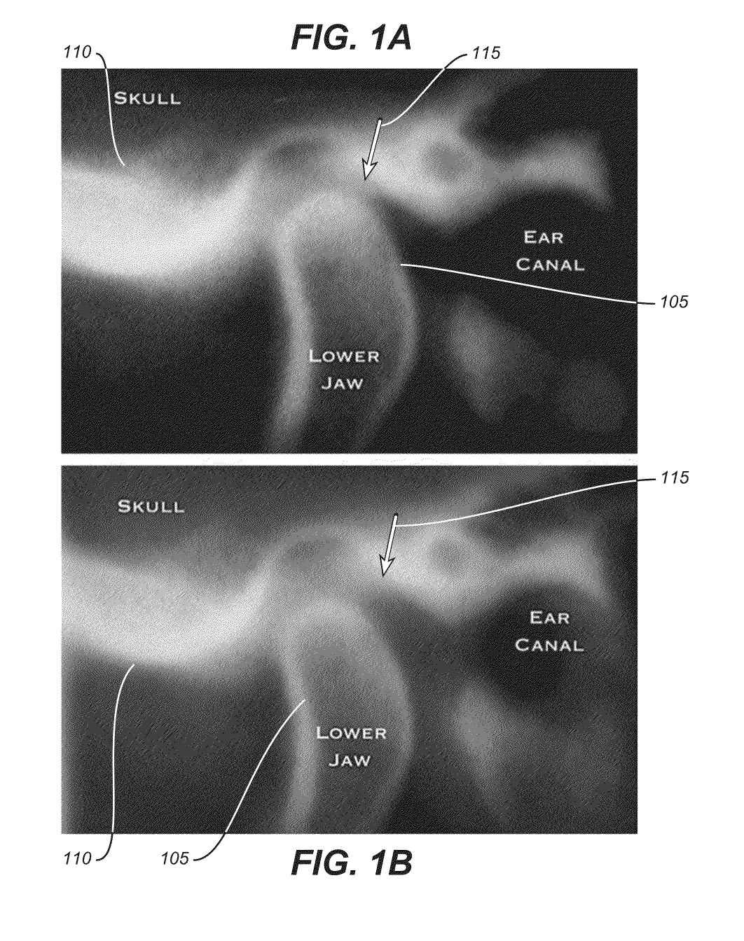

FIGS. 1A and 1B show x-ray photos taken with a complex motion tomography machine, in which a portion of the mandible of the patient is shown in relation to the patient's skull and ear canal. FIG. 1A shows the neck portion 105 of the mandible positioned centrally within a socket of the patient's skull 110. The arrow 115 points to the gap between the neck portion of the mandible and the socket of the skull. FIG. 1B shows the neck portion 105 of the mandible positioned left of center within the socket of the patient's skull 110, leaving a wider gap between the neck portion and the skull. In one embodiment, the testing appliance placed on the patient's teeth causes the patient's lower jaw (mandible) to be pushed forward. The x-rays taken of the patient without (FIG. 1A) and without (FIG. 1B) the testing appliance show the effect the testing appliance has on the patient's jaw positioning.

The dentist follows up with the patient after the testing appliance is worn for a prearranged period of time, to assess the patient's response to the fit of the testing appliance. For example, the dentist will inquire if the patient is comfortable or if any of the previous problematic symptoms of a poor bite positioning are subsiding.

### V. Designing a New Bite and Jaw Position

In various embodiments, based upon the x-rays taken via the complex motion tomography machine, patient feedback, information gathered from the testing appliance, and observations made by the dentist, the dentist prepares the patient's teeth for the application of the appliance to be bonded upon the current dental arch(s).

### VI. Trying-on the Appliances

In various embodiments, the temporary testing appliance is removed and the appliances intended to be permanent are slid onto the patient's teeth. The patient is reminded not to bite down on the appliance(s), due to the possibility that the appliance(s) might break and move. The patient is able to walk around, including going outside to natural light with assistance to consider the overall look and color of the appliance(s) at this time.

### VII. Bonding the Appliances onto the Patient's Teeth

In various embodiments, using the method described below, the dentist bonds onto the patient's teeth the appliance that was created based on the testing appliance, complex motion tomography images, examination, and/or observations. Embodiments provide a bonding method that does not require pain medication and the grinding down of healthy teeth. Further, in preparing the patient's teeth for the bonding of the appliance, the dentist uses a high powered magnification device. Via this magnification device, the dentist is able to view any surface contaminants present on the patient's teeth. The presence of surface contaminants on the patient's teeth has a negative impact upon the ability of the appliances to bond with the patient's teeth. The methodology which the dentist follows to bond the manufactured appliance to the patient's teeth is explained as follows (embodiments may include any of the below steps in various combinations):

1) Use advanced particle beam technology (micro air-abrasion) to blast the patient's teeth with silicon particles and remove all surface contamination completely, thereby significantly increasing the surface area on the teeth to which the appliance may bond. Most dentists do not use a particle beam because the dentists do not have a high speed and high volume suction system to vacuum up the sand blasted materials.

2) Apply hydrogen peroxide in some cases to decontaminate the tooth surface. The hydrogen peroxide may be applied to the patient's teeth or gum tissue with a syringe. The use of the particle beam technology may be determined for use by the dentist after using hydrogen peroxide based upon observations of the tooth surface condition.

3) Etch any surface contamination from the teeth, using either a blue etch or a green etch as determined by the dentists observation of the surface condition of the teeth. Factors the dentist takes into consideration when selecting an etch may be as follows. The blue etch may have 35% phosphoric acid, but tends to cause the patient's gums to bleed. Bleeding gums contaminate the surface area of the teeth that were just cleaned with a particle beam. The green etch may have 10% citric acid and 3% ferricchloride, but is most likely to avoid causing the patient's gums to bleed. Repeat etching may be necessary as determined by the dentist observing the surface condition of the teeth under magnification. 3) Apply a desensitizer and antiseptic material to the teeth (e.g., Gluma).

4) Apply a clear coat onto the patient's teeth (e.g., manufactured by the company 3M ESPE) and cure with a high intensity curing light.

5) Apply a material (e.g., a dual-cured, glass-reinforced composite resin, radiopaque composite system [ParaCore™]) to the tooth that builds the tooth up to become a shape that may then receive an appliance.

6) Apply a dental appliance to the tooth, such that the dental appliance is in contact with at least the patient's real tooth. Applying the dental appliance to the tooth includes the following steps:

a) Particle beam the appliance.

b) Etch the appliance with a hydrofluoric acid.

c) Apply Saline to the appliance.

d) Apply a 3M monomer and then the RelyX™ (of the company 3M ESPE) ultra cement in the desired color to the dental appliance.

e) Place the dental appliance on the patient's tooth, causing the cement to squeeze out from the space between the dental appliance and the patient's tooth.

f) Light cure the cement briefly.

g) Remove the extra cement that had squeezed out beyond the margins of the dental appliance while assuring that the chemical bonds already formed are preserved.

h) Light cure the cement.

7) Wash the patient's teeth.

8) Make adjustments to the appliance that was bonded onto the patient's teeth, such as adjusting the height (via grinding down the appliance) and polishing the appliance.

### VIII. Fine Tuning the Bite and Jaw Position of the Patient

In various embodiments, the following aspects may be observed by the dentist in order to determine if the appliance(s) should be adjusted: the patient's speech, diction, bite pressure, bite balance, and soft tissue movement; any interference that should be adjusted to improve the patient's speech clarity; comfort, the ability of the patient's lips to move naturally; the symmetrical display of the appliance(s) when the patient speaks; and possible cosmetic adjustments that should be done to the edges or contours of the appliance(s). The dentist also receives feedback from the patient, such as: how does the patient feel; are the pre-treatment symptoms like jaw pain or headaches gone; and is the patient comfortable with his new bite and jaw position. Using the data and results from the complex motion tomography images, taken with the permanent appliances in place, the dentist determines and conducts adjustments to the bite position to further optimize the jaw position. Furthermore, the fine tuning of the appliances can be determined as desirable by the dentist at any future point.

### IX. Protecting the Investment

In various embodiments, the dentist reminds the patient of the importance of oral hygiene and that the patient's daily health routine and maintenance is very much in their own hands. The dentist designs a custom night guard for the patient to wear while he is sleeping to maintain and preserve the ideal bite and jaw position.

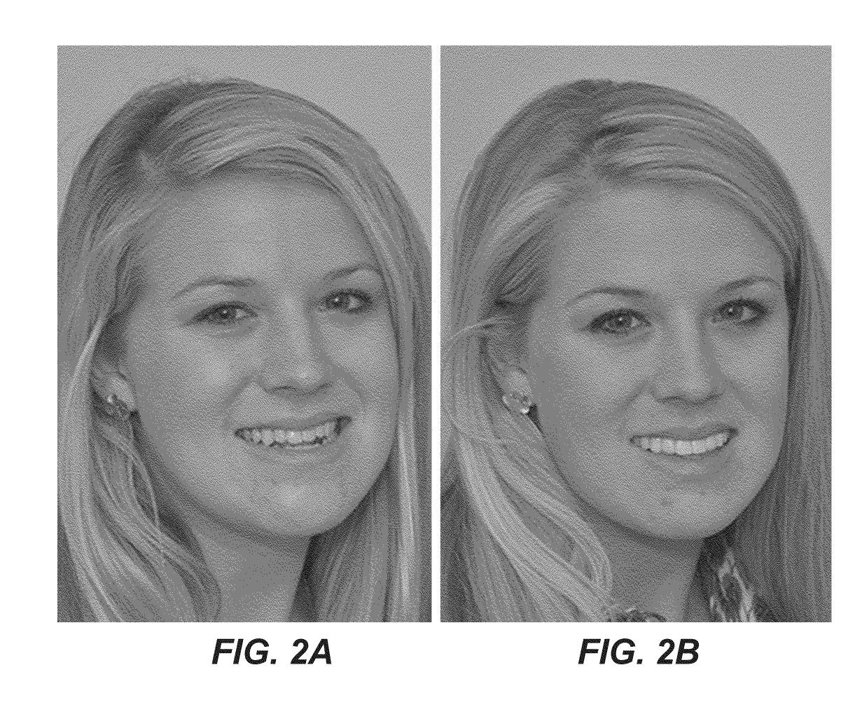

As will be explained below, FIGS. 2A, 2B, 2C, 2D, 3A, 3B, 4A and 4B illustrate before and after pictures of patients with an underbite an overbite, and an eroded or aging bite, the patients having received treatment according to embodiments described herein.

FIGS. 2A and 2B depict pictures of Patient A. FIG. 2A depicts a front view of Patient A before undergoing treatment according to embodiments. Patient A has an underbite with a large lower jaw and a small upper jaw. FIG. 2B depicts a front view of Patient A after undergoing treatment according to embodiments. In both FIGS. 2A and 2B, Patient A is biting her teeth together. In FIG. 2A, Patient A's front teeth do not even touch, making chewing and talking in a normal fashion impossible. In the past, patients wishing to correct an underbite such as this would frequently be directed to have surgery in which the jaw is cut and/or to wear braces for an extended period of time. However, embodiments of the present technology provide for a safer, non-surgical, and non-invasive (i.e. without grinding down teeth) answer to underbite correction. Embodiments idealize the patient's bite and jaw position to not only improve the smile, but also to improve the facial proportions. In other words, the ideal jaw position for the patient's bite is determined and then provided for with embodiments.

FIG. 2C depicts Patient A's profile before undergoing treatment according to embodiments. FIG. 2D depicts Patient A's profile after undergoing treatment according to embodiments. FIG. 2D illustrates Patient A's lower jaw having been physically improved and her bite having been corrected. Her lower lip and chin no longer jut out. FIG. 2C illustrates Patient A's underbite position that causes her chin and jaw to protrude. Patient A struggles to chew and speak normally. Additionally, her upper lip looks small and unsupported. FIG. 2D illustrates, upon the application of embodiments, Patient A's jaw in a position such that the appearance of the protruding chin is eliminated. Patient A's upper lip seems supported, rendering a fuller appearance. Further, Patient A's profile proportions appear to be more balanced and feminine.

In receiving treatment, none of Patient A's natural teeth were ground down or compromised in any way. Further, Patient A's treatment took two visits about two weeks apart from one another. During and after the treatment, Patient A did not experience any shots to alleviate pain, pain or discomfort.

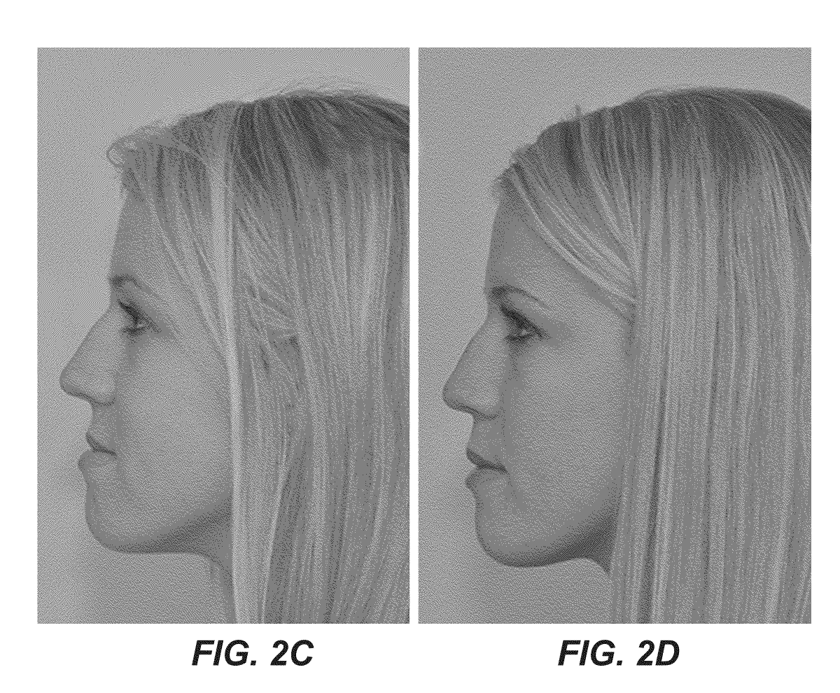

FIGS. 3A and 3B depict a side-profile of Patient B. FIG. 3A depicts Patient B before undergoing treatment. Patient B is shown having an overbite, deep folding of the soft tissue at the corners of her mouth, excess skin around her jawline and chin area, and squished lips are evident. FIG. 3B depicts Patient B after undergoing the treatment method according to embodiments. As shown, after the treatment according to embodiments is applied, Patient B no longer has an overbite, lips are better supported, folding at the sides of the mouth is significantly reduced and the skin if the jawline and chin appears tighter.

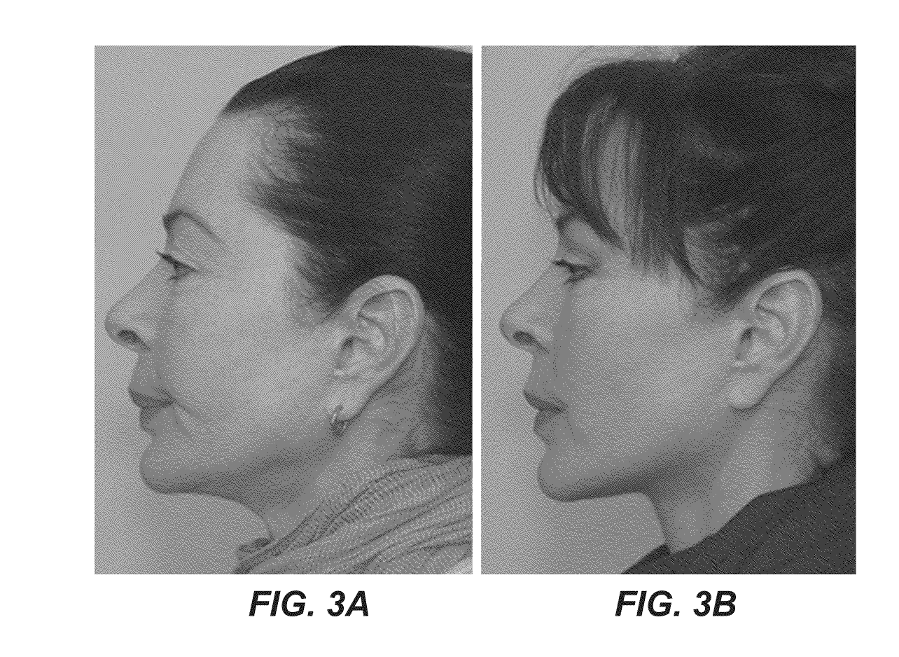

FIGS. 4A and 4B depict pictures of Patient C. FIG. 4A depicts Patient C before undergoing treatment. Patient C is shown having an eroding bite or aging bite, squished lips, turned down mouth (making her appear sad), folds at the corners of the mouth, and a short face that reveals the underside of her chin. FIG. 4B depicts Patient C after undergoing the treatment method according to the embodiments. As shown, after the treatment according to embodiments is applied, Patient C no longer has an eroded or aging bite, the mouth no longer turns down and is level, deep folds and infection at the corners of the mouth are gone, the face is elongated for a more oval facial shape, the underside of the chin is no longer visible, and lips are fuller.

In receiving treatment, none of Patient C's remaining healthy natural teeth were ground down or damaged in any way. All of the results were achieved according to the embodiments non-invasively and without compromising the health of her natural teeth.

### Example Methods and Systems

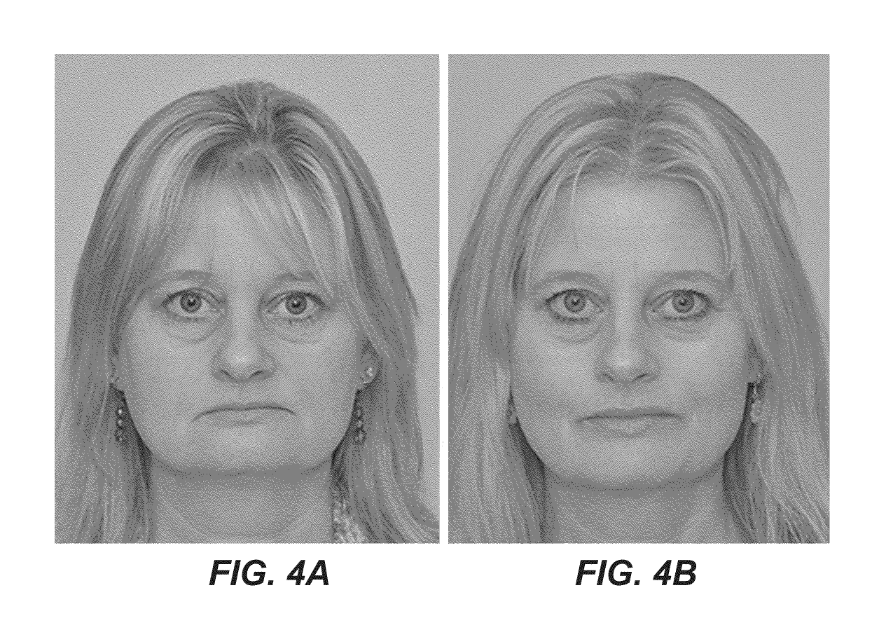

FIGS. 5, 6, 7, 8, 9 illustrate example methods for providing facial proportioning for a patient to realize an idealized bite and jaw positioning, in accordance with embodiments. With reference to FIG. 5 and as is already described herein, the method 500 for providing facial proportioning for a patient to realize an idealized bite and jaw positioning, in one embodiment, includes bonding 505 a set of dental appliances to at least one set of dental arches of the patient. The bonding 505 includes cleaning a surface of the at least one set of dental arches. It should be appreciated that a set of dental arches may be a set of one. In a patient's mouth, there exists the upper dental arch and the lower dental arch.

The cleaning includes: applying micro air-abrasion to surface contaminants on the surface of the at least one set of dental arches; etching away the surface contaminants; and applying a desensitizer and antiseptic material to the surface, wherein the at least one set of dental appliances provides a dental reconstruction that achieves an idealized bite and jaw positioning for the patient. In one embodiment, the cleaning further includes applying hydrogen peroxide to decontaminate the surface. In one embodiment, the application of the hydrogen peroxide occurs before the application of the micro air-abrasion to the surface contaminants, the etching of the surface contaminants; and the applying the desensitizer and antiseptic material to the surface of the at least one set of dental arches.

In one embodiment, the bonding 505 further includes applying a clear coating layer on the surface and curing the clear coating layer with a high intensity curing light. In another embodiment, the bonding 505 further includes applying a tooth building material to the surface, wherein the tooth building material is configured for building up a tooth of the at least one set of dental arches to become a shape that is enabled to receive a dental appliance. In one embodiment, the dental appliance is applied to the tooth, wherein the dental appliance is in contact with at least a portion of the tooth. In yet another embodiment, at least one set of dental appliances that is bonded onto at least one set of dental arches is adjusted.

In one embodiment, the method 500 further comprises: accessing 510 complex motion tomography images of a jaw of said patient; and determining, based at least in part on said complex motion tomography images, the idealized bite jaw positioning. In one embodiment, the complex motion tomography images include images of different sides of the patient.

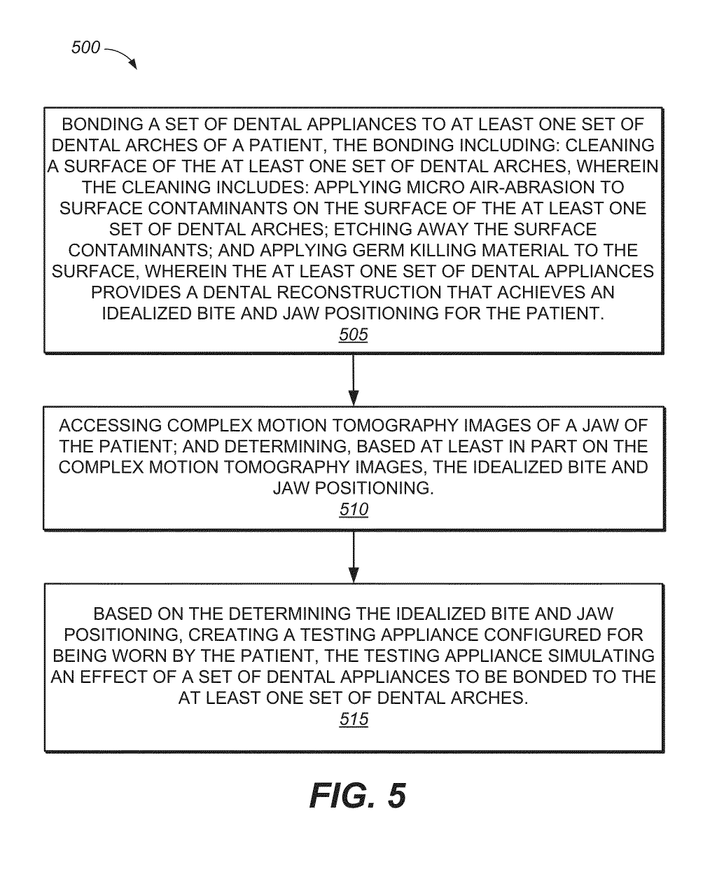

With reference to FIG. 6 and as is already described herein, the method 600 for providing facial proportioning for a patient to realize an idealized bite and jaw positioning, in one embodiment, includes accessing 605 complex motion tomography image of a jaw of a patient and determining 610, based at least in part on the complex motion tomography images, the idealized bite and jaw positioning.

In one embodiment, the method 600 further includes, based on the determining 610 the idealized bite and jaw positioning, creating 615 a testing appliance configured for being worn by the patient, said testing appliance simulating an effect of a set of dental appliances to be bonded to at least one set of dental arches of the patient. In one embodiment, the complex motion tomography images are images of different sides of the patient.

In one embodiment, the method 600 further includes bonding 620 a set of dental appliances to at least one set of dental arches of the patient, wherein the bonding includes: cleaning a surface of the at least one set of dental arches, wherein the cleaning includes: applying micro air-abrasion to surface contaminants on the surface of the at least one set of dental arches; etching away the surface contaminants; and applying a desensitizer and antiseptic (i.e., germ killing) material to the surface, wherein the at least one set of dental appliances provides a non-invasive dental reconstruction that achieves the idealized bite and jaw positioning for the patient.

In one embodiment, the cleaning further includes applying hydrogen peroxide to decontaminate the surface. In one embodiment, applying the hydrogen peroxide occurs before the applying of the micro air abrasion to the surface contaminants, the etching of the surface contaminants; and the applying of the desensitizer and antiseptic material to said surface.

In another embodiment, the bonding 620 further includes: applying a clear coating layer on the surface; and curing the clear coating surface with a high intensity curing light.

In one embodiment, the bonding 620 further includes: applying a tooth building material to the surface, wherein the tooth building material is configured for building up a tooth of the at least one set of dental arches to become a shape that is enabled to receive a dental crown.

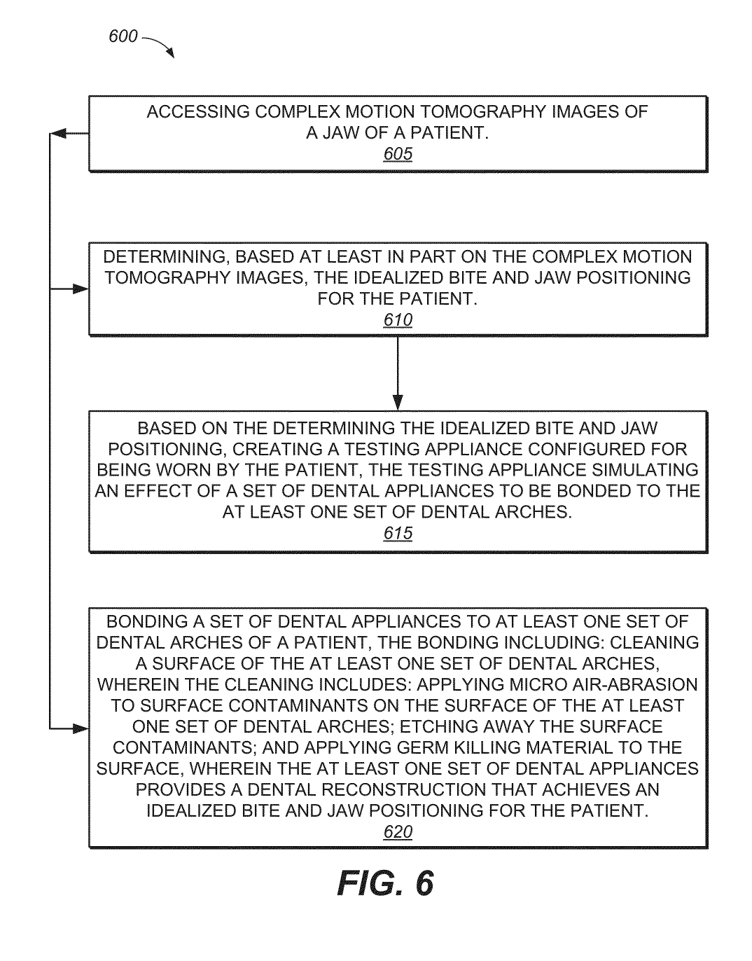

With reference to FIG. 7 and as is already described herein, the method 700 for providing facial proportioning for a patient to realize an idealized bite and jaw positioning, in one embodiment, includes: at step 705, gathering data about a dental patient through a dental examination of the patient; at step 710, determining a best bite tester that simulates the idealized bite and jaw positioning; at step 715, defining goals of tooth reconstruction associated with the patient; at step 720, based on the gathering data at step 705, the determining a best bite tester at step 710 and the defining goals at step 715, building a testing appliance to be worn by the patient during a test period; at step 725, testing assumptions during the test period of the testing appliance; at step 730, taking complex motion tomography images of the jaw of the patient during the test period; at step 735, based on the testing of the appliance, building dental appliances to be bonded onto at least one set of dental arches of the patient; at step 740, preparing at least one set of dental arches for an application of the dental appliances in accordance with at least the complex motion tomography photos; at step 745, trying-on of the dental appliances for the patient to consider before bonding of the dental appliance to the at least one set of dental arches; and at step 750, bonding a set of dental appliances to the at least one set of dental arches.

In one embodiment, the bonding of step 750 further includes cleaning a surface of the at least one set of dental arches, wherein the cleaning includes: applying micro air-abrasion to surface contaminants on the surface of the at least one set of dental arches; etching away the surface contaminants; and applying a desensitizer and antiseptic material to the surface, wherein the at least one set of dental appliances provides a non-invasive dental reconstruction that achieves the idealized bite jaw positioning for the patient.

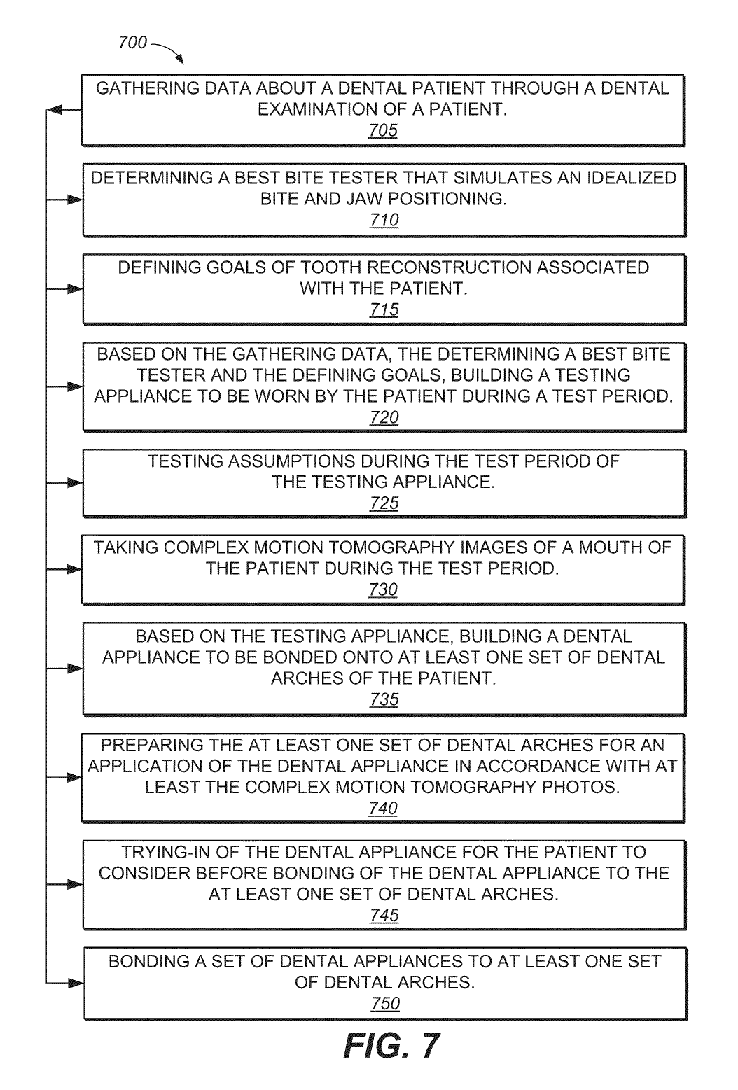

With reference to FIG. 8 and as is already described herein, the method 800 for providing facial proportioning for a patient to realize an idealized bite and jaw positioning, in one embodiment, includes: at step 805, accessing images of a jaw structure of said patient; at step 810, gathering data associated with at least one set of dental arches of said patient; at step 815, analyzing said images and said data; at step 820, based on said analyzing, determining an idealized bite and jaw positioning for said patient; and at step 825, based on said determining, applying dental appliances to every tooth of said at least one set of dental arches of said patient.

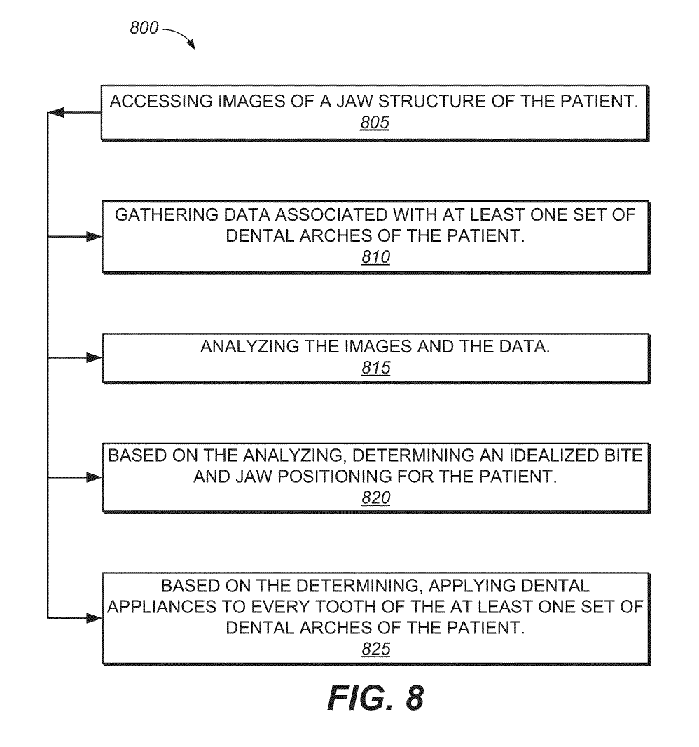

With reference to FIG. 9 and as already described herein, the method 900 for providing facial proportioning for a patient to realize an idealized bite and jaw positioning, in one embodiment, includes: at step 905, images of a jaw structure of a patient are accessed. At step 910, in one embodiment, based at least in part on the images, the idealized bite and jaw positioning for the patient is determined. In one embodiment, the images are complex motion tomography images.

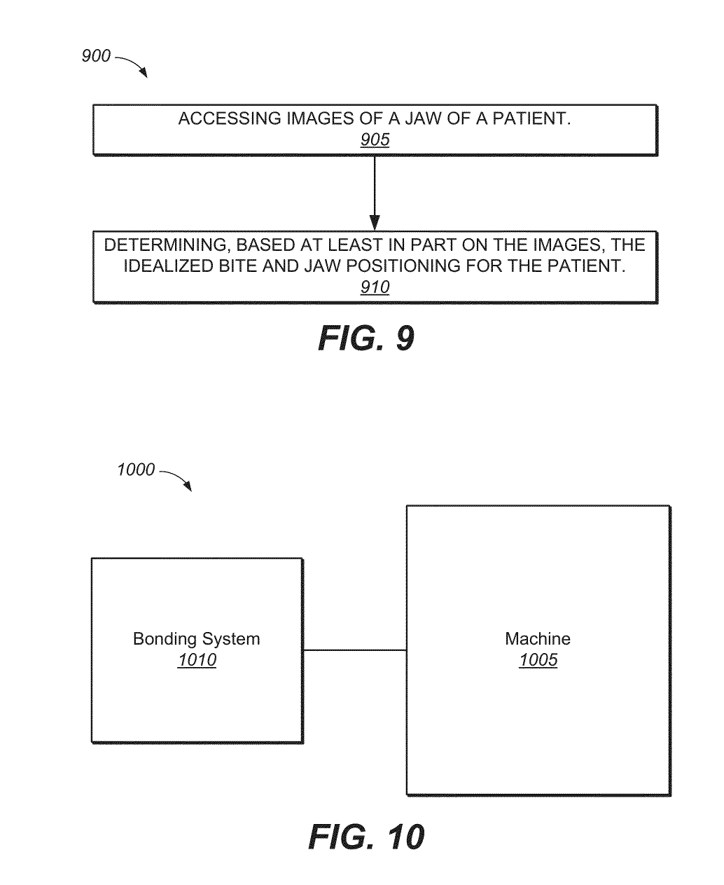

With reference to FIG. 10 and as already described herein, in one embodiment, the system 1000 for providing facial proportioning for a patient to realize an idealized bite and jaw positioning includes: a machine 1005 for generating images of a jaw of a patient, wherein the images provide information configured for enabling a determination of an idealized bite and jaw positioning of the patient; and a bonding system 1010 for bonding a set of dental appliances to at least one set of dental arches of the patient to achieve the idealized bite and jaw positioning non-invasively. The bonding system includes those materials, machines, and steps already described herein that enable applying the dental appliances (generated according to embodiments) to the patient's dental arches.

All statements herein reciting principles, aspects, and embodiments of the technology as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present technology, therefore, is not intended to be limited to the embodiments shown and described herein. Rather, the scope and spirit of present technology is embodied by the appended claims.

1. A method for providing facial proportioning for a patient to realize an idealized bite and jaw positioning non-invasively, said method comprising:
bonding a set of dental appliances to at least one set of dental arches of said patient, wherein said bonding comprises:
cleaning a surface of said at least one set of dental arches, wherein said cleaning comprises:
applying micro air-abrasion to surface contaminants on said surface of said at least one set of dental arches;
etching away said surface contaminants; and
applying a desensitizer and antiseptic material to said surface, wherein said at least one set of dental appliances provides a dental reconstruction that achieves an idealized bite and jaw positioning for said patient.

2. The method of claim 1, wherein said cleaning further comprises:
applying hydrogen peroxide to decontaminate said surface.

3. The method of claim 2, wherein said applying said hydrogen peroxide occurs before said applying said micro air-abrasion to said surface contaminants, said etching said surface contaminants; and said applying said a desensitizer and antiseptic material to said surface.

4. The method of claim 1, wherein said bonding further comprises:
applying a clear coating layer on said surface; and
curing said clear coating layer with a high intensity curing light.

5. The method of claim 1, wherein said bonding further comprises:
applying a tooth building material to said surface, wherein said tooth building material is configured for building up a tooth of said at least one set of dental arches to become a shape that is enabled to receive a dental appliance.

6. The method of claim 5, wherein said bonding further comprises:
applying said dental crown to said tooth, wherein said dental appliance is in contact with at least a portion of said tooth.

7. The method of claim 1, wherein said bonding further comprises:
adjusting said at least one set of dental appliances that is bonded onto said at least one set of dental arches.

8. The method of claim 1, further comprising:
accessing complex motion tomography images of a jaw of said patient; and
determining, based at least in part on said complex motion tomography images, said idealized bite and jaw positioning.

9. The method of claim 8, further comprising:
based on said determining said idealized bite and jaw positioning, creating a testing appliance configured for being worn by said patient, said testing appliance simulating an effect of a set of dental appliances to be bonded to said at least one set of dental arches.

10. The method of claim 8, wherein said complex motion tomography images comprise:
images of different sides of said patient.

11. A method for providing facial proportioning for a patient to realize an idealized bite and jaw positioning, said method comprising:
accessing complex motion tomography images of a jaw of said patient; and
determining, based at least in part on said complex motion tomography images, said idealized bite and jaw positioning.

12. The method of claim 11, further comprising:
based on said determining said idealized bite and jaw positioning, creating a testing appliance configured for being worn by said patient, said testing appliance simulating an effect of a set of dental appliances to be bonded to at least one set of dental arches of said patient.

13. The method of claim 11, wherein said complex motion tomography images comprise:
images of different sides of said patient.

14. The method of claim 11, further comprising:
bonding a set of dental appliances to at least one set of dental arches of said patient, wherein said bonding comprises:
cleaning a surface of said at least one set of dental arches, wherein said cleaning comprises:
applying micro air-abrasion to surface contaminants on said surface of said at least one set of dental arches;
etching away said surface contaminants; and
applying a desensitizer and antiseptic material to said surface, wherein said at least one set of dental appliances provides a dental reconstruction that achieves said idealized bite and jaw positioning for said patient.

15. The method of claim 14, wherein said cleaning further comprises:
applying hydrogen peroxide to decontaminate said surface.

16. The method of claim 15, wherein said applying hydrogen peroxide occurs before said applying said micro air abrasion to said surface contaminants, said etching said surface contaminants; and said applying said a desensitizer and antiseptic material to said surface.

17. The method of claim 14, wherein said bonding further comprises:
applying a clear coating layer on said surface; and
curing said clear coating surface with a high intensity curing light.

18. The method of claim 14, wherein said bonding further comprises:
applying a tooth building material to said surface, wherein said tooth building material is configured for building up a tooth of said at least one set of dental arches to become a shape that is enabled to receive a dental crown.

19. A method for providing facial proportioning for a patient to realize an idealized bite and jaw positioning, said method comprising:
gathering data about a dental patient through a dental examination of said patient;
determining a best bite tester that simulates said idealized bite and jaw positioning;
defining goals of tooth reconstruction associated with said patient;
based on said gathering data, said determining a best bite tester and said defining goals, building a testing appliance to be worn by said patient during a test period;
testing assumptions during said test period of said testing appliance;
taking complex motion tomography images of a jaw of said patient during said test period;
based on said testing appliance, building a dental appliance to be bonded onto at least one set of dental arches of said patient;
preparing said at least one set of dental arches for an application of said dental appliance in accordance with at least said complex motion tomography photos;
trying-on of said dental appliance for said patient to consider before bonding of said dental appliance to said at least one set of dental arches; and
bonding a set of dental appliances to said at least one set of dental arches.

20. The method of claim 19, wherein said bonding comprises:
cleaning a surface of said at least one set of dental arches, wherein said cleaning comprises:
applying micro air-abrasion to surface contaminants on said surface of said at least one set of dental arches;
etching away said surface contaminants; and
applying a desensitizer and antiseptic material to said surface, wherein said at least one set of dental appliances provides a dental reconstruction that achieves said idealized bite and jaw positioning for said patient.

21. A method for providing facial proportioning for a patient to realize an idealized bite and jaw positioning, said method comprising:
accessing images of a jaw structure of said patient;
gathering data associated with at least one set of dental arches of said patient;
analyzing said images and said data;
based on said analyzing, determining an idealized bite and jaw positioning for said patient; and
based on said determining, applying dental appliances to every tooth of said at least one set of dental arches of said patient.

22. A method for providing facial proportioning for a patient to realize an idealized bite and jaw positioning, said method comprising:
accessing images of a jaw of said patient; and
determining, based at least in part on said images, said idealized bite and jaw positioning for said patient.

23. The method of claim 22, wherein said accessing comprises:
accessing images of a jaw, wherein said images comprise complex motion tomography images of a jaw of said patient.

24. A system for providing facial proportioning for a patient to realize an idealized bite and jaw positioning, said system comprising:
a machine configured for generating images of a jaw of said patient, wherein said images provide information configured for enabling a determination of an idealized bite and jaw positioning of said patient; and
a bonding system for bonding a set of dental appliances to at least one set of dental arches of said patient to achieve said idealized bite and jaw positioning non-invasively.
